(19) United States
(12) Patent Application Publication
(10) Pub. No.: US 2009/0301960 A1
(43) Pub. Date: Dec. 10, 2009

(54) System for Filtering a Liquid

(76) Inventor: Gilles Blottiere, Blois (FR)

Correspondence Address: NIXON & VANDERHYE, PC, 901 NORTH GLEBE ROAD, 11TH FLOOR, ARLINGTON, VA, 22203, US

(21) Appl. No.: 12/084,566

(22) PCT Filed: Nov. 10, 2006
(86) PCT No.: PCT/EP2006/010896

§ 371 Date: Jan. 14, 2009

(30) Foreign Application Priority Data
Nov. 10, 2005 (FR) 05/11436

(51) Int. Cl. B01D 35/26; B01D 29/86

(52) U.S. Cl. 210/409

(57) ABSTRACT

The present invention concerns a system for filtering a liquid, comprising a pump designed to be immersed in a reservoir intended to contain a liquid in order to pump it, the pump being provided with a filter able to filter the liquid admitted into the pump. According to the invention, the filtration system comprises a device intended to reduce the clogging of the filter during the functioning of the pump. Thus, the filtration system functions for longer before it is necessary to proceed with its cleaning or replacement.

The present invention concerns a system for filtering liquid. Such a system is used for filtering a lubricant or a liquid intended to cool and lubricate a cutting tool used for example in the building industry.

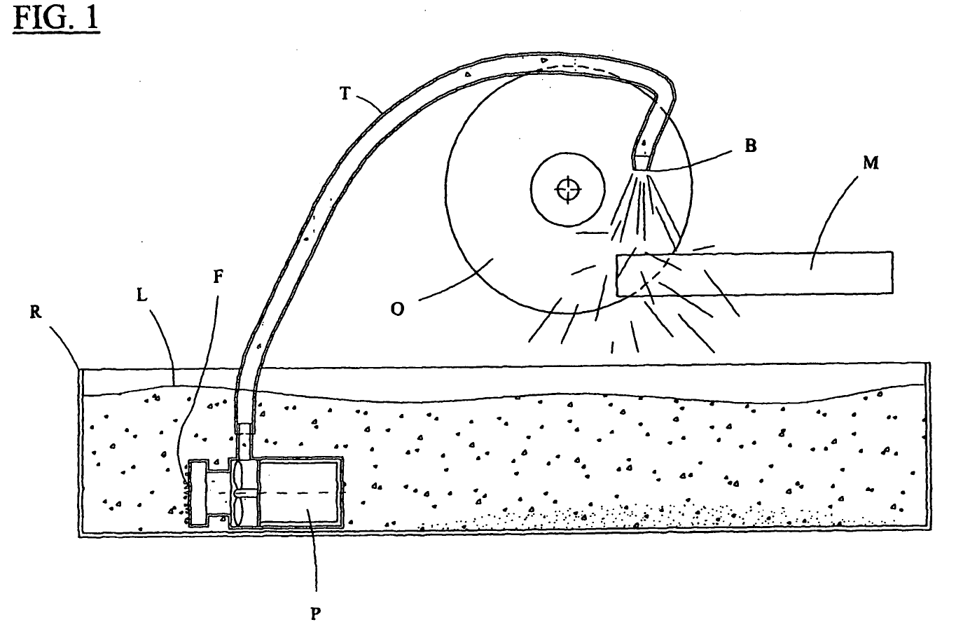

In the latter application, the filtration system generally comprises, as is shown in FIG. 1, a reservoir R intended to contain a certain quantity of liquid L, a pump P that is here immersed in the liquid L and that can in this way pump the liquid L in order to discharge it, through a pipe T, the outlet of which, provided with an atomisation nose B, is oriented in the direction of a tool O working on an element M of material so as essentially to cool and lubricate it. The liquid sprayed onto the tool O falls directly by gravity into the reservoir R or is conducted therein by a collector, not shown. Spraying the liquid L also makes it possible to take away the particles of material torn from the element M by the tool O in order to transport them into the reservoir R.

In order to prevent these particles being able to damage or prematurely wear the pump P, a filter F, usually consisting of a grille, is placed at the suction zone of the said pump. However, it is easy for this filter to become dirty, as shown by the conglomeration of particles at the entry to the filter. The filter can also allow to pass into the pump sufficiently large particles that are liable to create damage to the latter and that can also accumulate, for example, in the atomisation nose B. Monitoring and early maintenance of the latter should therefore be provided. It is certainly possible to reduce the size of the perforations in the grille, but then the filter becomes clogged more rapidly.

The aim of the invention is therefore to propose a system for filtering a liquid adapted in particular to cool and lubricate a tool and able to reduce the rate of clogging of the filter.

To this end, a system for filtering a liquid is proposed, comprising a pump designed to be immersed in a reservoir intended to contain a liquid in order to pump it, the pump being provided with a filter able to filter the liquid admitted into the pump, the said filtration system being remarkable in that it comprises a device intended to reduce the clogging of the filter.

Thus the filtration system functions for longer before it is necessary to proceed with its cleaning or replacement.

According to an additional characteristic of the invention, the device intended to reduce the clogging of the filter is provided with a diffuser disposed so as to be able to spray liquid tangentially onto the filtering part of the filter.

The arrangement of the diffuser makes it possible to push the particles in suspension in the liquid beyond the filtering part of the filter.

According to an additional characteristic of the invention, the device intended to reduce the clogging of the filter consists of a bypass T-piece mounted on the outlet orifice of the pump, the lateral outlet of the T-piece being connected, by means of a pipe, to a diffuser disposed at the periphery of the filter.

According to an additional characteristic of the invention, the diffuser and the filter consist of the same piece.

According to an additional characteristic of the invention, the device intended to reduce the clogging of the filter consists of a bypass T-piece mounted on the outlet orifice of the pump, the lateral outlet of the T-piece being connected to an angled tube, the free end of which is conformed so as to form a diffuser.

According to an additional characteristic of the invention, the device intended to reduce the clogging of the filter consists of a conduit integrated in the body of the pump and its filter, the conduit being connected with the outlet orifice so as to form a bypass, the outlet of the conduit being conformed so as to form a diffuser.

According to an additional characteristic of the invention, the device intended to reduce the clogging of the filter consists of a pipe integrated in the body of the pump and its filter, the conduit being connected with a second outlet orifice of the pump so as to form a bypass, the outlet of the conduit being conformed so as to form a diffuser.

According to an additional characteristic of the invention, the outlet of the diffuser consists of a cylindrical cavity reduced by a hemisphere opening onto a rectangular groove.

According to an additional characteristic of the invention, the outlet of the diffuser consists of an oblong opening.

According to an additional characteristic of the invention, the filtering part of the filter consists of a perforated planar wall.

The characteristics of the invention mentioned above, as well as others, will emerge more clearly from a reading of the following description of an example embodiment, the said description being given in relation to the accompanying drawings, among which:

FIG. 1 depicts a view in section of a system for filtering a liquid for cooling and lubricating a tool known from the prior art,

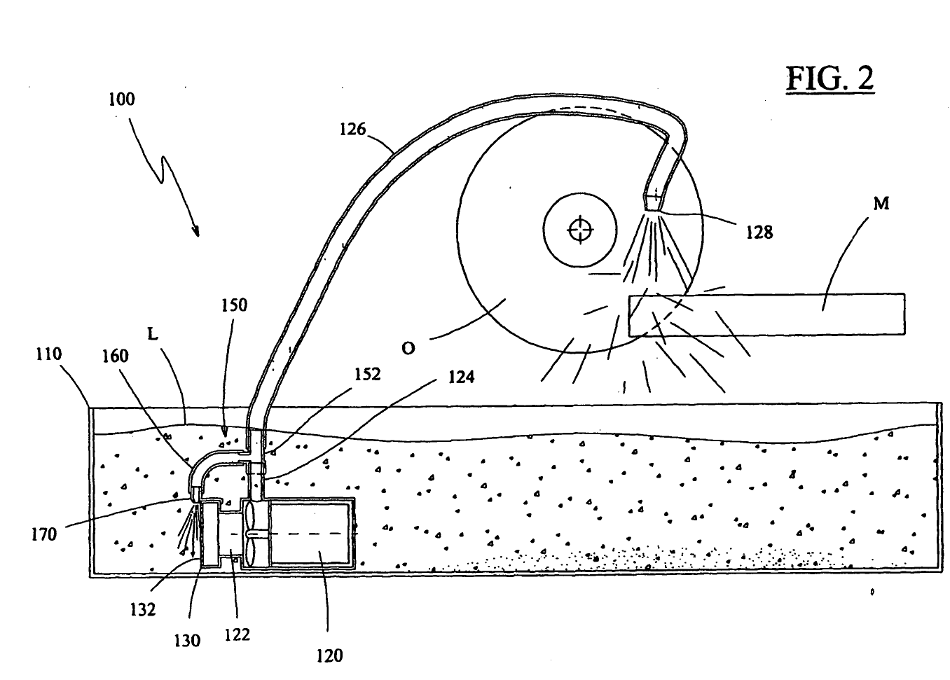

FIG. 2 depicts a view in section of a system for filtering a liquid for cooling and lubricating a tool according to the invention,

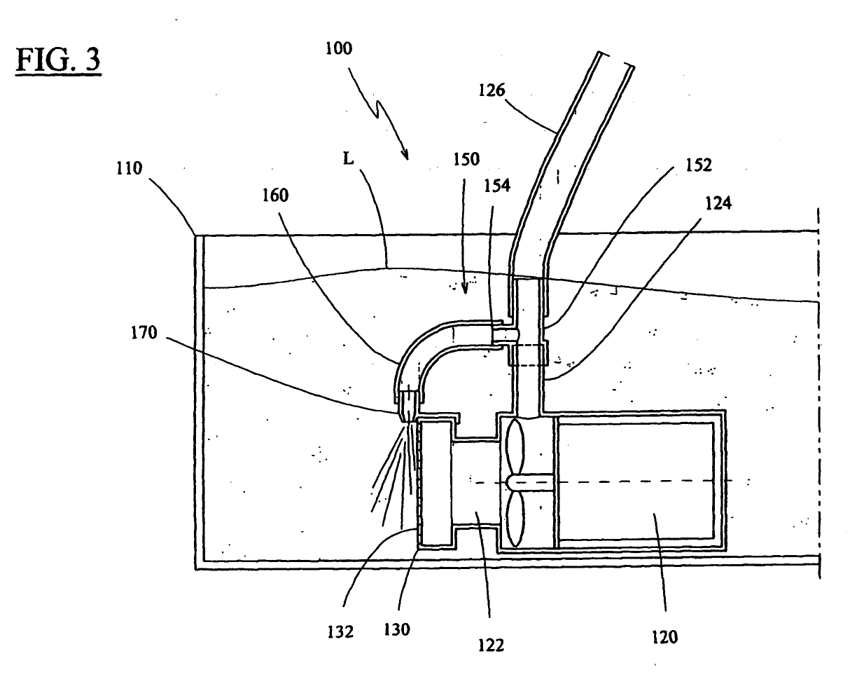

FIG. 3 depicts a view in detail of a device intended to reduce the clogging of a filter of a system for filtering a liquid for cooling and lubricating a tool according to the invention,

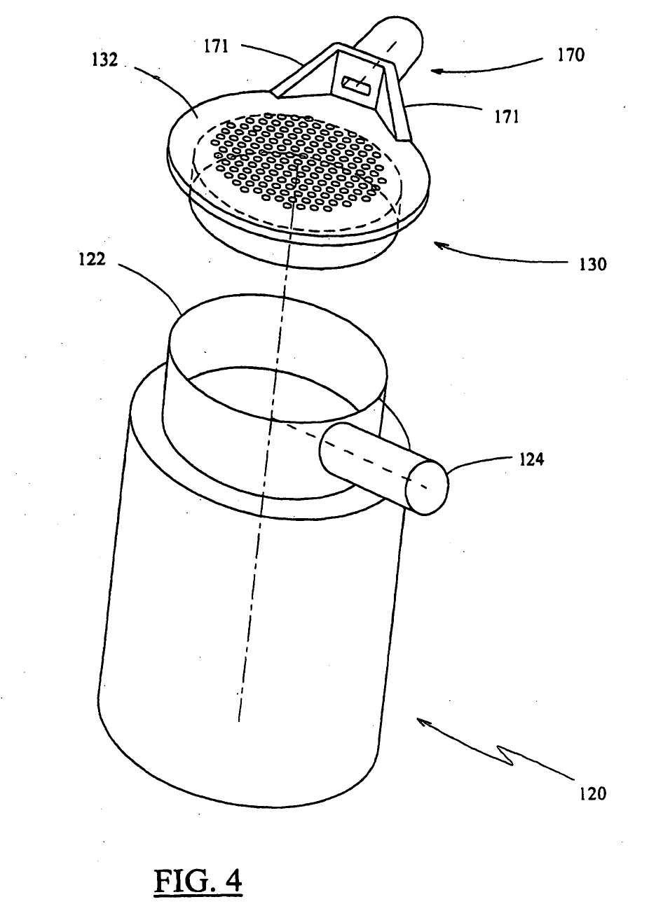

FIG. 4 depicts a view in perspective of a pump and a filter for a system for filtering a liquid for cooling and lubricating a tool according to the invention,

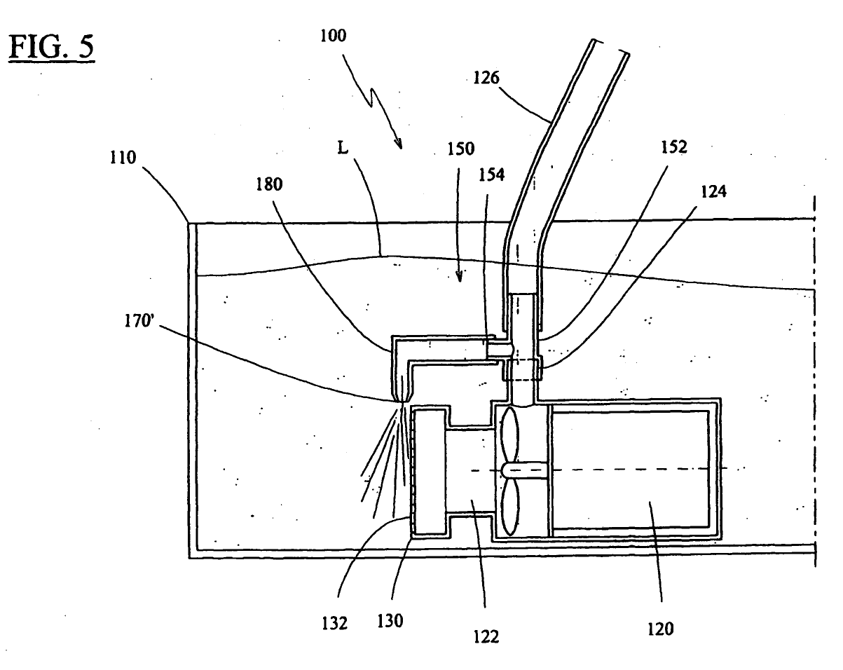

FIG. 5 depicts a view of a detail of a first variant embodiment of a device intended to reduce the clogging of the filter for a system for filtering a liquid for cooling and lubricating a tool according to the invention,

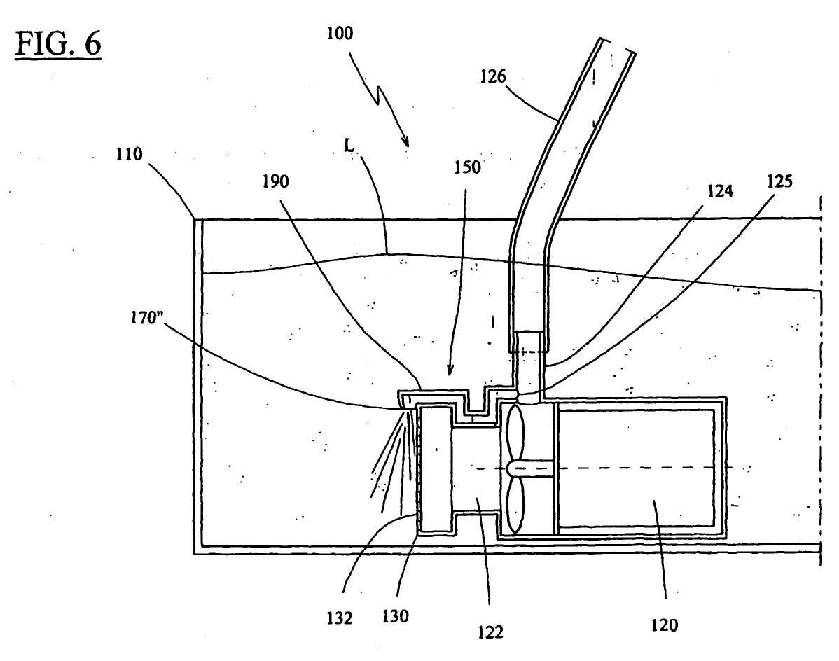

FIG. 6 depicts a view of a detail of a second variant embodiment of the device intended to reduce the clogging of a filter for a system for filtering a liquid for cooling and lubricating a tool according to the invention; and

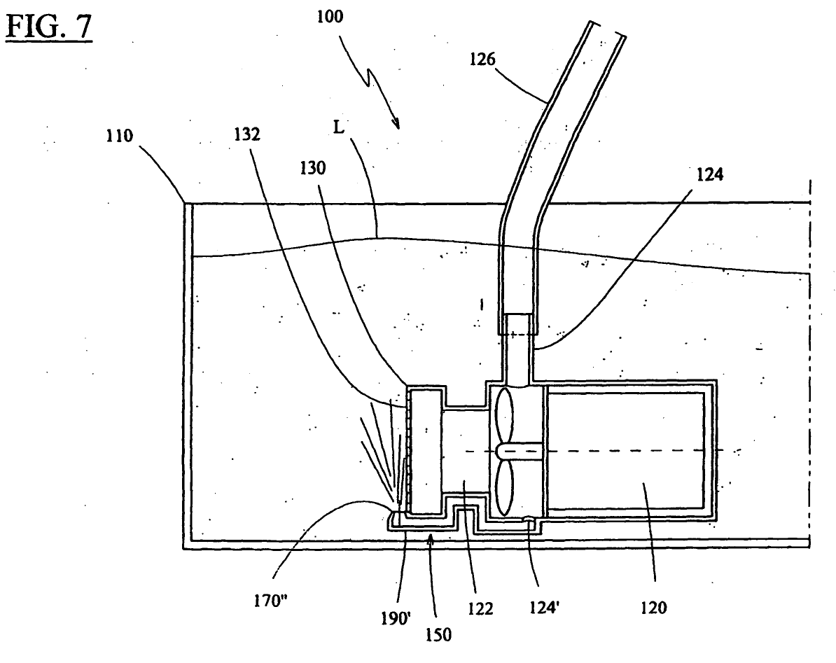

FIG. 7 depicts a view of a detail of a third variant embodiment of a device intended to reduce the clogging of the filter of a system for filtering a liquid for cooling and lubricating a tool according to the invention.

The filtration system of the invention is intended to filter a liquid such as a lubricant or a liquid intended to cool and lubricate a tool. Such an application is described in the remainder of the disclosure of the invention.

Thus, in FIG. 2, the filtration system 100 that is depicted is designed to filter a liquid intended to lubricate and cool a tool O able to machine an element M of material.

The tool O can consist of a tile saw, a construction saw, a boring machine, a drilling machine or a wall-mounted saw, able to work an element of material to be used in the field of building construction.

The filtration system 100 comprises essentially a reservoir 110 able to contain a quantity of liquid L such as water, a pump 120 able to pump the liquid in order to spray the tool O, a filter 130 disposed upstream of the pump 120 in order to filter the liquid sucked by the pump 120 as well as a device 150 intended to reduce the clogging of the filter 130.

The pump 120, which is here immersed in the reservoir 110, is provided with a liquid inlet orifice 122, which opens out in the filter 130, and a liquid outlet orifice 124, which is connected to one or more pipes 126, each terminating in a nozzle 120 that it is necessary to orient towards the tool O. In this FIG. 2, the filter 130 is integrated in the body of the pump 120. The filtering part 132 of the filter 130 advantageously consists of a perforated planar wall, the perforations in which limit the size and quantity of particles able to be sucked into the pump during operation thereof.

Thus, while the pump 120 is operating, the latter sucks, through the filter 130, the liquid L contained in the reservoir 110 in order to discharge it so that it can spray the tool O. The liquid next falls directly by gravity into the reservoir 110 or is returned to it by a collector, not shown, so that the filtration system 100 functions practically in closed circuit. The particles torn off the element M by the tool O are discharged by the sprayed liquid and fall into the reservoir 110. The latter also forms a settler for the particles, which finally rest on the bottom of the reservoir 110, as shown by the agglutination visible in this FIG. 2.

The device 150 intended to reduce the clogging of the filter 130, which will be described in its various embodiments, is designed to inject, tangentially to the wall constituting the filtering part 132, liquid contained in the reservoir 110 and which comes from the flow emerging from the pump 120. More precisely the device 150 makes it possible to inject liquid onto the face of the filtering part that is exposed to the liquid to be filtered. In this way, the particles in suspension in the liquid that would be liable to obstruct the filtering part 132 are repelled. The particles that might have been able to stick on the filtering part 132 are also detached.

To this end and in FIG. 3, a bypass T-piece 152 is mounted on the outlet orifice 124 of the pump 120. The lateral outlet 154 from this T-piece is connected, by means of a pipe 160, to a diffuser 170 fixed to the periphery of the filter 130. The outlet of the diffuser 170 is turned so that the jet of liquid that leaves it during the functioning of the pump 120 can sweep the filtering part 132, as shown by the fine lines merging at the outlet from the diffuser 170. In this embodiment, the device 150 can be fitted on a commercially available pump and its filter.

In FIG. 4, the filter 130 is of the removable type, able to be mounted by fitting on the inlet orifice 122 of the pump 120. Moreover, the diffuser 170 and the filter 130 are formed from the same piece. Scoops 171, disposed on each side of the outlet of the diffuser 170, channel the flow of liquid leaving the diffuser 170 onto the surface of the filtering part 132.

In a first variant embodiment of the device 150, depicted in FIG. 5, the pipe and its diffuser are replaced by an angled tube 180, a free end of which is conformed so as to form a diffuser 170′.

In a second variant embodiment depicted in FIG. 6, the device 150 consists of a conduit 190 integrated in the body of the pump 120 and its associated filter. The conduit 190 is connected directly, without an intermediate T-piece, with the outlet orifice 124 of the pump 120, through a hole 125, thus forming a bypass to the outlet orifice 124. The outlet of the conduit 190 is conformed so as to form a diffuser 170″.

In a third variant embodiment depicted in FIG. 7, the conduit 190′ of the device 150, with a structure similar to that of the second variant, is here connected to a second outlet orifice 124′ of the pump 120, thus forming a bypass to the outlet orifice 124.

The outlet of the diffuser 170, 170′ and 170″ can take the form of a narrowed opening, for example the form of a cylindrical cavity reduced by a hemisphere opening onto a rectangular groove or the form of an oblong opening as appears in FIG. 4.

The flow rate of liquid circulating in the diffuser 170, 170′, 170″ is approximately equal to 10% of that circulating in the outlet orifice 124 during the functioning of the pump 120.

The functioning of the filtration system 100 is established in the following manner. The reservoir 110 is filled with water. The tool O and pump 120 are started. The pump 120 then discharges through the pipe or pipes 126 in order to spray the tool O.

It must be stated here that, during its functioning, the pump 120, through its suction, causes a flow of liquid that carries particles in suspension towards the filtering part 132.

A proportion of this output of the pump 120 is taken off, which is thus used to send pressurised water tangentially onto the filtering part 132 of the filter 130.

Because of the functioning of the pump 120, the particles in suspension that move in the vicinity of the filtering part 132 are repelled from the said filtering part 132, so that the filter gets dirty much more slowly.

It is thus possible to reduce the size of the mesh of the filtering part in order to increase the efficacy of the filter 130, to allow the use of a nozzle with a finer orifice for the purpose of creating a water mist. The service life of the pump is thus increased. It is also possible to use the water for longer.

The filtration system of the invention delays the clogging of the filter.

It increases the mean duration of functioning of the pump.

It functions automatically without requiring any special maintenance.

Its manufacturing cost is modest compared with the advantages that it procures.

1-9. (canceled)

10. A system for filtering a liquid, comprising a pump designed to be immersed in a reservoir intended to contain a liquid for pumping it, the pump being provided with a filter able to filter the liquid admitted into the pump, the filtration system comprising a device intended to reduce the clogging of the filter during the functioning of the pump, characterized in that the device is provided with a diffuser disposed so as to be able to spray liquid tangentially onto the face of the filtering part of the filter that is intended to be exposed to the liquid to be filtered.

11. A filtration system according to claim 1, wherein the device consists of a bypass T-piece mounted on the outlet orifice of the pump, the lateral outlet of the T-piece being connected, by means of a channel to a diffuser disposed a the periphery of the filter.

12. A filtration system according to claim 2, wherein the diffuser and the filter consist of the same piece.

13. A filtration system according to claim 2, wherein the device consists of a bypass T-piece mounted on the outlet orifice of the pump, the lateral outlet of the T-piece being connected to an angled tube, the free end of which is conformed so as to form a diffuser.

14. A filtration system according to claim 1, wherein the device consists of a conduit integrated in the body of the pump and its filter, the conduit being connected with the outlet orifice so as to form a bypass, the outlet of the conduit being confirmed so as to form a diffuser.

15. A filtration system according to claim 1, wherein the device consists of a conduit integrated in the body of the pump and its filter, the conduit being connected with a second outlet orifice of the pump so as to form a bypass, the outlet of the conduit being confirmed so as to form a diffuser.

16. A filtration system according to claim 1, wherein the outlet of the diffuser consists of a cylindrical cavity reduced by a hemisphere opening onto a rectangular groove.

17. A filtration system according to claim 1, wherein the outlet of the diffuser consists of an oblong opening.

18. A filtration system according to claim 1, wherein the filtering part of the filter consists of a perforated planar wall.
